(19) United States
(12) Patent Application Publication
(10) Pub. No.: US 2013/0098249 A1
(43) Pub. Date: Apr. 25, 2013

(54) Coffee Apparatus

(71) Applicants: Michael Fidler, Columbus, OH (US); Mark Swanson, Columbus, OH (US); Christopher Hawker, Columbus, OH (US)

(72) Inventors: Michael Fidler, Columbus, OH (US); Mark Swanson, Columbus, OH (US); Christopher Hawker, Columbus, OH (US)

(21) Appl. No.: 13/651,462

(22) Filed: Oct. 14, 2012

Related U.S. Application Data
(60) Provisional application No. 61/547,181, filed on Oct. 14, 2011.

(51) Int. Cl. A47J 31/00

(52) U.S. Cl. CPC A47J 31/002
USPC 99/283; 99/285; 99/280

(57) ABSTRACT

Disclosed herein are devices for brewing coffee in conjunction with an electro-conductivity sensor. Detailed information on various example embodiments of the inventions are provided in the Detailed Description below, and the inventions are defined by the appended claims.

### CLAIM OF PRIORITY

This filing is related to and claims priority to provisional application No. 61/547,181 to Michael L. Fidler filed on Oct. 14, 2011, which is incorporated by reference herein in its entirety.

### BACKGROUND/FIELD

There is a relationship between the total dissolved solids in brewed coffee and specific electrical conductivity 1.(EC). The conductivity varies directly with respect to the mole fraction of the total dissolved solids (TDS), and with respect to temperature of the solution. It is established that while TDS cannot be used as a direct measurement of the flavor or character of a coffee, it is a proxy indicator of brew strength 2, and can be used to compare the strength of two brews of coffee (Table 1). The Specialty Coffee Association of America has defined an ideal standard for TDS of coffee of between 1.15% and 1.35% solubles concentration, corresponding to 18.0% to 22.0% extraction from the nominal weight of coffee 3.

Reliably achieving this target extraction percentage from simple ground coffee has been the goal of many coffee brewers, but is a complex process affected by the differing rates of extraction at different temperatures, differing rates of extraction from different grain sizes of ground coffee, and varying composition of coffee beans themselves. As most brew methods rely on imprecise trial and error measurements of extraction rates as water is exposed to coffee grounds in various ways (drip, press, percolation, etc).

### SUMMARY

According to a first embodiment of the present disclosure, an apparatus for brewing coffee includes; a vessel for holding fluid with an electroconductivity sensor in fluidic communication therewith, with the electroconductivity sensor being in electronic communication with a microcomputer M; A value for a target electroconductivity reading T, which is stored in M; a display configured to generate visual feedback from M; a feedback means capable of generating an output from M upon attainment of T for the solution within the vessel.

According to further embodiments of the present disclosure, there is a data input means operatively coupled to M, whereby a user may modify T.

According to further embodiments of the present disclosure, temperature readings are taken as a moving average of a group of readings.

According to further embodiments of the present disclosure, T is a slowing in the rate of change in electroconductivity signaling conclusion of a useful coffee extraction.

According to further embodiments of the present disclosure, the data input means is a tactile button or touchscreen on the face of the apparatus.

According to further embodiments of the present disclosure, there is an electric heater integral to the device in thermal communication with the fluid and electronic communication with M.

According to further embodiments of the present disclosure, M modulates power to the heater in order to maintain a fluid temperature selected from the range of 65 to 95 degrees Celsius.

According to further embodiments of the present disclosure, T may be offset automatically or by user input means to correspond to a desired brew preference by a user.

According to further embodiments of the present disclosure, the output from M is a visual or acoustic notification to a user to physically extract the coffee solids from the solution.

According to further embodiments of the present disclosure, there is a mesh or filtered plunger coupled to the vessel which is capable of being manually actuated by a user to separate fluid and solid components within the vessel.

According to further embodiments of the present disclosure, the output is electronic and causes a linear drive mechanically coupled to a mesh or filtered plunger within the vessel whose motion separates fluid and solid components within the vessel.

According to further embodiments of the present disclosure, the output is electronic and causes a pump to operate which substantially evacuates the fluid component from the vessel into another vessel passing through a porous body, leaving behind solids.

According to further embodiments of the present disclosure, M is in electronic communication with a portable computer and capable of receiving T values therefrom.

According to further embodiments of the present disclosure, an apparatus for brewing coffee, the apparatus includes; a vessel for holding fluid with an electroconductivity sensor in fluidic communication therewith, with the electroconductivity sensor being in electronic communication with a microcomputer M; a data input means operatively coupled to M, whereby a user may enter a target electroconductivity reading T; a display configured to generate visual feedback of the present electroconductivity reading; a feedback means capable of generating an output from M upon attainment of T for the solution within the vessel; there is a mesh or filtered plunger coupled to the vessel which is capable of separating solid from fluid components within the vessel.

According to further embodiments of the present disclosure, an apparatus for brewing coffee includes a vessel for holding fluid with an electroconductivity sensor in fluidic communication therewith, with the electroconductivity sensor being in electronic communication with a microcomputer M; a data input means operatively coupled to M, whereby a user may enter a target electroconductivity reading T; a display configured to generate visual feedback of the present electroconductivity reading; a feedback means capable of generating an output from M upon attainment of T for the solution within the vessel; there is a pump in fluidic communication with the interior of the vessel which is driven by the output of M.

According to further embodiments of the present disclosure, M issues a notification to a user upon attainment of a selected temperature T to add an extractant to the fluid in order to begin brewing.

According to further embodiments of the present disclosure, M has a memory to store presets for various T values.

### BRIEF DESCRIPTION OF THE FIGURES:

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows block diagram of a logic controlled within a coffee apparatus.

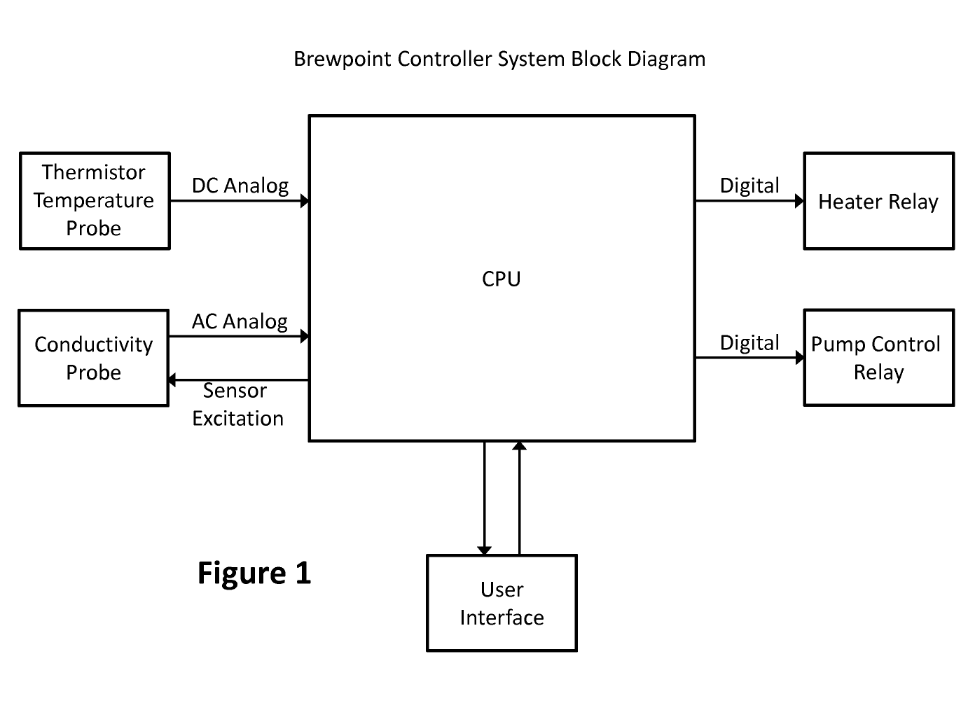

### DETAILED DESCRIPTION OF THE EXEMPLARY EMBODIMENTS

The present invention uses direct electronic monitoring of the EC of a container of water and ground coffee (called “the brew”). The EC of the brew rises as ground coffee is exposed to water and soluble compounds comprising the coffee enter solution. The invention eliminates the variable of temperature by maintaining a constant temperature (within reasonable variation) using a heat source, thus a baseline EC for the brew can be set as a target. Once this target EC is reached, the present invention then moves the coffee liquid to a secondary container away from the ground coffee beans to end the brewing process. This may be accomplished by vacuum extraction or other means known in the art such as plungers or filtration.

Since it is recognized that for each type of coffee bean the EC to TDS relationship will not be the same as for other types of coffee beans, the electronic system is configured to be adapted to allow the user to select a “brew strength” along a scale that will either increase or decrease the target EC that the electronic monitoring system uses to end the brewing process. Palatable coffee is generally achieved at a target EC of between around ₄ and 8 mS, but, of course, individual taste preferences differ and coffee varieties differ, both are factors that will affect the target EC desired for any given temperature. Thus for each type of coffee the user brews, a setting for target EC can be known either in advance or after a test brew to achieve a reliable standard brew for that type of coffee at the desired temperature. Brew strength can also be calibrated using external measurements, such as a photo spectrometer calibrated to read the TDS of coffee solutions as outlined in US Patent 2010/0085560A1 Apr. 8, 2010 4.

As temperature plays a key role in the flavor of coffee, the present invention may be adapted to allow the user to select the brew temperature from a range of allowable temperatures and the electronic control system will select (by calculation or from memory) the approximate correct target EC for the brew. This makes it possible to directly compare flavor profiles across a range of brewing temperatures at approximately equal brew strength. This allows a user to not only find the optimal target brew strength for a given coffee, but also to find the optimal brew temperature for each coffee variety determined by the taste preferences of the user.

Vacuum Unit: One possible embodiment using this technology is a fully automatic vacuum extraction. This device utilizes a temperature controlled brew chamber to perform the brewing and brew monitoring. A microprocessor or similar device in an electronic control unit monitors the temperature (T) and controls a heating element that holds the water at a user selected or default temperature. An electrical conductivity sensor is in communication with the brew chamber and is further in communication with the electronic control unit which continuously monitors the electrical conductivity of the brew liquid and can be programmed to trigger brew cessation in one of two ways: 1) The brew liquid reaches a previously selected target electrical conductivity, or 2) The brew liquid electrical conductivity has stopped rising or its rate of change slows to a predetermined value, indicating a brew that is no longer extracting the desired components of coffee. Once one of these two conditions has been met the microprocessor sends a control signal to a vacuum pump which produces negative pressure within a holding container and causes the liquid to move from the brewing chamber to a second container via a tube connected to or near the bottom of the brew chamber beneath a filter mechanism. The holding container may be insulated to prevent the need to supply additional heat to the already brewed coffee, which may damage the flavor of the brewed coffee beverage. The insulated holding container can be made removable to allow the user to freely transport the beverage.

Automatic Press: In a second embodiment using this technology the device utilizes a removable temperature controlled brew chamber to perform the brewing and brew monitoring. A microprocessor or similar device in an electronic control unit monitors the temperature (T) and controls a heating element that holds the water at a user selected or default temperature. An electrical conductivity sensor is in communication with the brew chamber and is further in communication with the electronic control unit which continuously monitors the electrical conductivity of the brew liquid and can be programmed to trigger brew cessation in one of two ways: 1) The brew liquid reaches a previously selected target electrical conductivity, or 2) The brew liquid electrical conductivity has stopped rising or its rate of change slows to a predetermined value, indicating a brew that is no longer extracting the desired components of coffee. Once one of these two conditions has been met the microprocessor sends a control signal to activate a linear actuator to depress a plunger with a filter screen on the bottom to compress the grounds at the bottom of the brew chamber, thus halting the brew. The holding container may be insulated to prevent the need to supply additional heat to the already brewed coffee, which may damage the flavor of the brewed coffee beverage.

Monitored Press: In a third embodiment using this technology the device utilizes a temperature controlled brew chamber integral with a heating element to perform the brewing and brew monitoring. A microprocessor or similar device in an electronic control unit monitors the temperature (T) and controls the heating element which holds the water at a user selected or default temperature. An electrical conductivity sensor is in communication with the brew chamber and is further in communication with the electronic control unit which continuously monitors the electrical conductivity of the brew liquid and can be programmed to trigger brew cessation in one of two ways: 1) The brew liquid reaches a previously selected target electrical conductivity, or 2) The brew liquid electrical conductivity has stopped rising or its rate of change slows to a predetermined value, indicating a brew that is no longer extracting the desired components of coffee. Once one of these two conditions has been met the microprocessor sends a control signal to activate an alert, (visual, audible, or wirelessly transmitted to a digital device such as a cellular telephone or tablet computer) to alert the user to depress a plunger with a filter screen on the bottom to compress the grounds at the bottom of the brew chamber, thus halting the brew. The holding container may be insulated to prevent the need to supply additional heat to the already brewed coffee, which may damage the flavor of the brewed coffee beverage.

Pod Brewer: In a fourth embodiment using this technology, the device would be a pod-style coffee maker and utilize the aforementioned sensor technology to monitor the brew output from the machine and adjust the parameters of the brew on the fly to optimize the results.

Method for measuring EC: The challenge for a device like this is to measure EC in an inexpensive, accurate, and consistent fashion. One potential circuit was developed to be as low cost as possible, and yet still deliver high performance. It involves a simple digital microprocessor that applies a charge across two conductors put into the medium in order to charge a capacitor. The higher the conductivity, the faster the cap charges. The processor compares the time of a measurement to a calibrated table that maps the time measurement to a specific conductivity. The circuit need merely be calibrated for the EC levels required by the application. The processor should be at minimum an 8 bit microcontroller with a 16 bit timer and comparator function. These are among the simplest and least expensive processors available, for example the Freescale RS08 family. Other methods of measuring the electroconductivity of a solution are known in the arts and applicable to this application as well.

Scalability: The hereindescribed apparatus and method is volume agnostic and can be applied to volumes from 1 cup of coffee to potentially gallons. At higher volumes, it is likely that agitation will be required to prevent grounds from settling and achieve a homogenous dissolved solids/conductivity throughout the brew chamber.

Wireless compatibility: The hereindescribed apparatus and method is by nature digital, and therefore readily adapts to control via mobile devices utilizing Bluetooth technology, 802.x, or other wireless data transmission technologies, such as smartphones and tablet computers. Said control is contemplated as operating in both directions, both to provide values for setting the operating parameters of the device and also for reading back process information for display on the remote device.

Features implemented on a remote device such as a phone or tablet:
1) Access local water supply data through GPS or other location-detection services. This will aid in determining temperature and stopping point during the brew cycle. Starting brew recipes (consisting of temperature and target EC values can help dial in the best brew for your local water source.)
2) User driven database will help refine best practices in terms of target EC, temperature, or extraction times for each roast, origin and blend.
3) We can offer roasters access to our criteria based on industry standards such as Agtron and TDS (total dissolved solids)
4) It is also possible to have the machine compile data for personal use within a record that is then able to be analyzed and applied.
5) You can change temperature and dwell time.

The GUI will have a simple slider interface and a website you can access to share discoveries as well as challenges.

A further embodiment of the present invention will now be described:

The controller for the device implements the coffee brewing algorithm in hardware. The controller is microprocessor based and interfaces to the following devices:
Thermistor temperature probe
Liquid conductivity probe
Extraction vacuum pump/filter
Immersion or plate style AC mains powered heater
User interface

The controller is responsible for monitoring the brewing process based on the brew temperature and liquid conductivity and terminating it via an extraction vacuum pump. See the attached basic system block diagram of the controller.

The brewing process is started by adding water to a brewing vessel. The filter is placed into the vessel and the sensor wand (containing the temperature and conductivity sensors) is inserted into the vessel. For embodiments where the sensors are integral to or permanently installed upon the vessel, this step is unnecessary. The vessel is heated either using an immersion heating element or via an external source. Once these items are in place, the user starts the brewing process via the user interface. The brewing process is divided into ₄ phases. They are:
Pre-brew testing
Heating
Brewing
Extraction

Before the start of the brewing cycle, a “pre-brew test” check is done on the temperature and conductivity sensors to verify that they are able to make correct measurements. If either sensor is found to be open circuited or shorted, the brewing process is canceled and an error message is displayed on the user interface. In addition, the initial temperature and conductivity of the water is tested to assure it is within reasonable guidelines prior to the start of the brew. Once brewing is started, the controller continues to monitor the health of both sensors (short or open) and if an error is detected, the brewing process is halted.

Once the Pre-brew tests are verified, the actual brewing sequence is started. The water in the vessel is heated to a preset desired brewing temperature. A closed loop control system regulates the temperature. In the present system, an electromechanical relay operates the heater in an on-off manner. This type of relay was chosen for the heater control function due to its very high efficiency as compared with typical solid state relays. The control algorithm compares the actual and desired temperature of the vessel liquid and turns the heating element on or off based on this comparison. In order to keep the relay from chattering near the temperature set point, hysteresis is used. In addition, a lockout timer is used limit the cycle rate of the relay. When the relay transitions from an on to off condition, a countdown timer is started. Until this timer reaches a count of zero, the relay cannot be re-activated even if the temperature drops below the set point. This prevents excessive relay cycling which would shorten its life.

There are further embodiments of the present disclosure, wherein a heater may be selected based on the wattage and volume of the vessel, thereby allowing for relatively constant temperature within the vessel without the need for cycling on/off or otherwise modulating power to the heater.

Once the desired temperature is reached, a beeper instructs the user to add the coffee into the brewing vessel. At this time, the controller monitors the vessel liquid conductivity and compares this to a predefined target point to determine if the brewing process has ended. Once this condition is met, the brewing process is halted

According to further embodiments of the present disclosure, coffee solids may already be present in the vessel prior to the initiation of the heating process, or combined with heated water when such is ready at the appropriate temperature.

Further, there are three EC readings contemplated at which the brew will be determined to be complete. The first of these is when the EC sensor reports a target EC reading with sufficient statistical accuracy, the next occurs when the EC measurements being read by the sensor plateau and no longer rise, indicating a cessation of extraction, and the last of these occurs when the rate of change of the extraction slows to indicate that the desires substances are no longer being extracted from a quantity of coffee.

When the brew process is terminated, the controller turns off the heater and activates an extraction vacuum pump. This pump filters and extracts the finished brew from the vessel into a holding vessel. Once this operation is complete, the brewing process is ended. In the embodiments where plungers or notifications are used to signal completion, the controller sends out this signal instead.

Sensor Operation and Data Acquisition:

According to certain embodiments of the present disclosure, the CPU is programmed to take 100 temperature and conductivity readings per second. The data obtained through the sampling process, is smoothed via an 8 point moving average. The temperature control and conductivity comparison algorithms operate on the averaged data steam at the 100 Hz acquisition rate. This insures fast response while filtering noise present in the data.

According to certain embodiments of the present disclosure, the brew water temperature is measured via a thermistor configured as a voltage divider network. The thermistor resistance varies as a function of temperature and is configured as the lower leg of a DC resistive voltage divider network. The top leg of the divider is a fixed known resistance. The divider is powered by the CPU logic power supply (5 Vdc). An on-chip A/D converter is used to measure the voltage formed by the divider. Since the A/D uses the same logic supply reference as the voltage divider, the measurement is ratio metric and thus immune to variations of the supply voltage. Because the resistance of the thermistor is not a linear function of temperature, a 5th order polynomial is used to linearize the sensor reading. Provisions are made in the software to calibrate the sensor to adjust for tolerances in the actual thermistor.

According to certain embodiments of the present disclosure, the conductivity sensor is constructed of two electrodes spaced a fixed distance apart. When immersed, the sensor measures the ability of the solution to pass electrical current. Conductivity is the inverse of electrical resistance. However, it is not possible to use DC current to make the measurement because ionic potentials develop in the solution in the presence of a polarized source. The type of material used for the electrodes is also critical as the wrong choice, results in similar effects. In this case, stainless steel has been utilized. It is inexpensive and relatively easy to machine. AC current is used to avoid the polarization issues described above. The CPU generates a 1 KHz 50% duty cycle square wave and is coupled via a capacitor to the sensor to remove any DC component. This is fed to the sensor via a voltage divider network with a fixed known resistance forming the top of the network, and the sensor at the bottom. On every 10th rising edge of the generated square wave, two A/D conversions are performed. The first reading measures the instantaneous voltage at the top of the voltage divider. The second reading is performed immediately following and measures the divider voltage. This is done to compensate for any variations in the generated square wave amplitude. Given these two readings, the conductance of the sensor is calculated. This value is multiplied by a predefined calibration constant which corrects for the sensor electrode geometry.

While a coffee apparatus been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed is:

1. An apparatus for brewing coffee, the apparatus comprising;
a. a vessel for holding fluid with an electroconductivity sensor in fluidic communication therewith, with the electroconductivity sensor being in electronic communication with a microcomputer M;
b. A value for a target electroconductivity reading T, which is stored in M;
c. a display configured to generate visual feedback from M;
d. a feedback means capable of generating an output from M upon attainment of T for the solution within the vessel.

2. The apparatus of claim 1, where there is a data input means operatively coupled to M, whereby a user may modify T.

3. The apparatus of claim 2, wherein temperature readings are taken as a moving average of a group of readings.

4. The apparatus of claim 1, wherein T corresponds to the range of 4 to 8 mS/cm.

5. The apparatus of claim 1, wherein T is a slowing in the rate of change in electroconductivity signaling conclusion of a useful coffee extraction.

6. The apparatus of claim 1, wherein the data input means is a tactile button or touchscreen on the face of the apparatus.

7. The apparatus of claim 1, wherein there is an electric heater integral to the device in thermal communication with the fluid and electronic communication with M.

8. The apparatus of claim 1, wherein M modulates power to the heater in order to maintain a fluid temperature selected from the range of 65 to 95 degrees Celsius.

9. The apparatus of claim 1, wherein T may be offset automatically or by user input means to correspond to a desired brew preference by a user.

10. The apparatus of claim 1, wherein the output from M is a visual or acoustic notification to a user to physically extract the coffee solids from the solution.

11. The apparatus of claim 10, wherein there is a mesh or filtered plunger coupled to the vessel which is capable of being manually actuated by a user to separate fluid and solid components within the vessel.

12. The apparatus of claim 1, wherein the output is electronic and causes a linear drive mechanically coupled to a mesh or filtered plunger within the vessel whose motion separates fluid and solid components within the vessel.

13. The apparatus of claim 1, the output is electronic and causes a pump to operate which substantially evacuates the fluid component from the vessel into another vessel passing through a porous body, leaving behind solids.

14. The apparatus of claim 1, wherein M is in electronic communication with a portable computer and capable of receiving T values therefrom.

15. An apparatus for brewing coffee, the apparatus comprising;
a vessel for holding fluid with an electroconductivity sensor in fluidic communication therewith, with the electroconductivity sensor being in electronic communication with a microcomputer M; a data input means operatively coupled to M, whereby a user may enter a target electroconductivity reading T; a display configured to generate visual feedback of the present electroconductivity reading; a feedback means capable of generating an output from M upon attainment of T for the solution within the vessel; there is a mesh or filtered plunger coupled to the vessel which is capable of separating solid from fluid components within the vessel.

16. The apparatus of claim 1, wherein the plunger is electronically actuated upon the output from M.

17. An apparatus for brewing coffee, the apparatus comprising;
a vessel for holding fluid with an electroconductivity sensor in fluidic communication therewith, with the electroconductivity sensor being in electronic communication with a microcomputer M; a data input means operatively coupled to M, whereby a user may enter a target electroconductivity reading T; a display configured to generate visual feedback of the present electroconductivity reading; a feedback means capable of generating an output from M upon attainment of T for the solution within the vessel; there is a pump in fluidic communication with the interior of the vessel which is driven by the output of M.

18. The apparatus of claim 3, wherein M issues a notification to a user upon attainment of a selected temperature T to add an extractant to the fluid in order to begin brewing.

19. The apparatus of claim 1, wherein M has a memory to store presets for various T values.
